(19) United States
(12) Patent Application Publication
(10) Pub. No.: US 2007/0157427 A1
(43) Pub. Date: Jul. 12, 2007

(54) Bamboo handle

(76) Inventor: He Ni, Jiangsu (CN)

Correspondence Address: VENABLE LLP, P.O. BOX 34385, WASHINGTON, DC, 20043-9998, US

(21) Appl. No.: 10/587,037

(22) PCT Filed: Nov. 14, 2005
(86) PCT No.: PCT/CN05/01915

§ 371 Date: Jul. 24, 2006

(30) Foreign Application Priority Data
Nov. 17, 2004 (CN) 20042010006.4

(51) Int. Cl. E05B 1/00

(52) U.S. Cl. 16/110.1

(57) ABSTRACT

A bamboo handle with round cross section, which is made of one centric bamboo chip bonded with four circumjacent bamboo chips. The centric bamboo chip has quadrate cross section, and the circumjacent bamboo chip has curved cross section. The infarctate bamboo handle bonded with several bamboo chips not only possesses the excellent nature of the bamboo or wood handle, but also avoids the disadvantages of bamboo or wood handle, such as surface asperity, split and lower intension.

### FIELD OF THE INVENTION

The present utility model relates to a bamboo wood handle.

### BACKGROUND OF THE INVENTION

A handle is occasionally used in various tools of our daily life, such as a mop, a besom etc,. Presently, the handles used are generally made of metal, wood or bamboo. However, a metal handle has a high cost manufacturing and is easy to be corroded. A wood handle consumes much wood during manufacture and is low in intension. A bamboo handle which is manufactured by natural bamboos generally has burl in its surface, thus it's asperate in surface and easy to split. Handles made of natural bamboo may also vary in diameter.

### SUMMARY OF THE INVENTION

The object of the present invention is to provide an infarctate handle formed by bonding several bamboo or wood chips, which not only keeps the excellent nature of the bamboo or wood handle, but also avoids the disadvantages of bamboo or wood handle, such as surface asperity, split, lower intension.

In one technical solution of the present invention, it is provided with a bamboo or wood handle with a round cross section, which is formed by bonding a centric chip with four circumjacent chips, the centric chip having a quadrate cross section and the circumjacent chips each having a curved cross section.

In a detailed technical solution of the present invention, it is provided with a bamboo or wood handle with a round cross section, which is formed by bonding a centric chip with four circumjacent chips, the centric chip having a quadrate cross section and the circumjacent chips each having a curved cross section. The cross section of each circumjacent chip is comprised of a curved border, a short straight border and a long straight border. The short straight border with a length shorter than the long straight border is perpendicular to the long straight border. Each long straight border is bonded with the centric chip and each short straight border is bonded with the neighboring circumjacent chip at a portion where the long straight border of the circumjacent chip extends from the centric chip.

In a further detailed technical solution of the present invention, it is provided with a bamboo or wood handle with a round cross section, which is formed by bonding a centric chip with four circumjacent chips, the centric chip having a quadrate cross section and the circumjacent chips each having a curved cross section. The cross section of each circumjacent chip is comprised of a curved border, a short straight border and a long straight border. The short straight border with a length shorter than the long straight border is perpendicular to the long straight border. Each long straight border is bonded with the centric chip and each short straight border is bonded with the neighboring circumjacent chip at a portion where the long straight border of the circumjacent chip extends from the centric chip. The centric chip is formed by bonding two same small chips each having a quadrate cross section.

The present invention is advantageous over the prior arts in that:

1. The handle according to the present invention is formed by bonding several bamboo or wood chips, thus it not only keeps the excellent nature of bamboo or wood, but also avoids the disadvantages of the bamboo or wood handle, such as surface asperity, split, and lower intension.

2. The handle according to the present invention is formed by bonding centric chip with circumjacent chips thus it's well designed in configuration, economic in material use and high in intension.

### BRIEF DESCRIPTION OF THE DRAWINGS

Preferred embodiments of the invention will now be described with reference to the drawings, in which:

FIG. 1 shows a front view of the present invention;

FIG. 2 shows a cross-sectional view of the present invention in FIG. 1.

In the drawings: central chip 1; small chip 11; circumjacent chip 2; curved border 21; short straight border 22; long straight border 23.

### DESCRIPTION OF PREFERRED EMBODIMENTS OF THE INVENTION

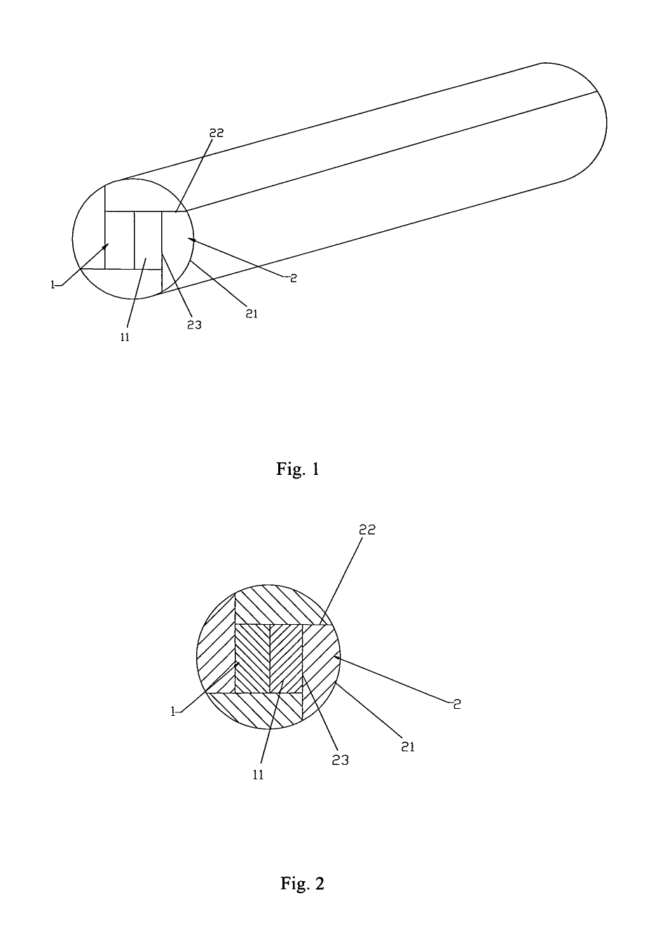

Referring to FIG. 1 and FIG. 2, a handle having a round cross section is formed by bonding a centric chip 1 with four circumjacent chips 2. The centric chip 1 has a quadrate cross section and the circumjacent chips 2 have curved cross sections. The centric chip 1 is formed by bonding two of the same small chips 11 each having a quadrate cross section. The cross section of each circumjacent chip 2 is comprised of a curved border 21, a short straight border 22 and a long straight border 23. The short straight border 22 with a length shorter than the long straight border 23 is perpendicular to the long straight border 23. Each long straight border 23 is bonded with the centric chip 1 and each short straight border 22 is bonded with the long straight border of the neighboring circumjacent chip 2 at a portion where the long straight border 23 extends from the centric chip 1.

The handle according to the present invention is formed by bonding several bamboo or wood chips, thus it not only keeps the excellent nature of bamboo or wood, but also avoids the disadvantages of the bamboo or wood handle, such as surface asperity, split, and lower intension. Besides, the handle according to the present invention is formed by bonding centric chip with circumjacent chips thus it's well designed in configuration, economic in material use and high in intension.

The handle according the present invention can be fabricated with wood chips or bamboo chips. It can also be fabricated with composite material of bamboo and wood.

1-3. (canceled)

4. A handle comprising
a centric chip having a quadrate cross section;
four circumjacent chips, each of which has a curved cross section;
wherein the handle with a round cross section is formed by bonding the centric chip with four circumjacent chips.

5. The handle as claimed in claim 4, wherein the cross section of each circumjacent chip is comprised of a curved border, a short straight border, and a long straight border,
wherein the short straight border with a length shorter than the long straight border is perpendicular to the long straight border,
wherein each long straight border is bonded with the centric chip and each short straight border is bonded with the long straight border of the neighboring circumjacent chip at a portion where the long straight border extends from the centric chip.

6. The handle as claimed in claim 4, wherein the centric chip is formed by bonding two small chips each having a quadrate cross section.
